(19) United States
(12) Patent Application Publication
(10) Pub. No.: US 2009/0063357 A1
(43) Pub. Date: Mar. 5, 2009

(54) SYSTEM AND METHOD FOR AUTOMATIC TARIFF NEGOTIATION

(75) Inventors: Edmund C. Munger, Crownsville, MD (US); Robert D. Short, III, Leesburg, VA (US)

Correspondence Address: MCDERMOTT WILL & EMERY LLP, 28 STATE STREET, BOSTON, MA, 02109-1775, US

(73) Assignee: Virnetx, Inc., A Delaware Corporation, Scott Valley, CA (US)

(21) Appl. No.: 12/201,873

(22) Filed: Aug. 29, 2008

Related U.S. Application Data
(60) Provisional application No. 60/969,226, filed on Aug. 31, 2007.

(51) Int. Cl. G06Q 30/00

(52) U.S. Cl. 705/80

(57) ABSTRACT

A method of and system for providing opportunistic internet connections is disclosed. The method and system receive a request from a first electronic device having network account with a first entity to negotiate a connection for a second electronic device; determine a network account associated with the second electronic device; and automatically connect the second electronic device in accordance with one or more rules including determination of a tariff for making the connection.

### RELATED APPLICATION

This application claims priority to provisional application Ser. No. 60/969,226 filed Aug. 31, 2007, the entirety of which are incorporated herein by reference.

### FIELD OF THE DISCLOSURE

This application relates generally to systems for and methods of secure network communications, and more specifically to systems for and methods of automatically negotiating tariffs for connecting a device to a communication network carrier.

### BACKGROUND

With the continuing advancements in computing and networking semiconductor technologies, sophisticated computing and network interface capabilities are finding their way into an ever increasing number of devices. The resulting reductions in size and cost has enabled the creation of “smart, connected” devices in an ever increasing range of commonly available products (e.g. automobiles, household appliances, personal and facility security systems, health and maintenance monitoring systems, tracking systems, laptops, PDAs, cell phones, etc.). The impending explosive growth in new network-enabled devices is going to open up new domains of application, many of which will involve devices that are geographically dispersed with any combination of heterogeneous mixes of fixed and mobile devices. The transition of the Internet from the current IPV4 to the IPV6 addressing protocols will solve the current shortage of available public Internet addresses needed to support this anticipated growth.

However, the need for secure, private and seamless connectivity between these geographically dispersed and dynamic heterogeneous collection of device networks will require a shift in how the industry thinks about networks. Traditionally, networks have been defined by their physical connections between two or more devices. For example, a typical local area network (LAN) includes a set of network devices (workstations, printers, servers, etc.) interconnected by hardware hubs and switches. This type of network is usually isolated from the Internet and other networks by gateways which provide network address translation (NAT), firewall, and routing services. The security of a specific LAN from the outside world is largely achieved through this physical isolation and the packet filtering performed by the firewall function. Today, network enclaves are largely defined by physical boundaries. The physical boundaries may be augmented by a limited number of dedicated virtual private network (VPN) tunnels between geographically separated sub-networks and VPN gateway servers that allow remote device users to securely reach back to and communicate within the specific LAN to which they have authorized access.

Typical carrier networks today allow only devices with established accounts to connect to its network. For example, a user having Verizon high speed internet service available at home can connect to the Internet only via the home connection. It would be desirable to allow the device to connect via another network, if away from the home.

### SUMMARY

In accordance with some embodiments, a method of providing opportunistic internet connections is provided. The method comprises: receiving a request from a first electronic device having network account with a first entity to negotiate a connection for a second electronic device; determining a network account associated with the second electronic device; and automatically connecting the second electronic device in accordance with one or more rules including determination of a tariff for making the connection. In some embodiments, automatically connecting the second device includes negotiating the tariff for making the connection. In some embodiments, the first entity and second entity are the same entity, and the first electronic device connects to the second electronic device remotely by roaming through a third entity.

In accordance with some embodiments, a system for automatically negotiating network connections is provided. The system comprises a financial server configured to create a financial account associated with a secure virtual private domain, a negotiation server configured to automatically negotiate tariffs for connecting one or more devices in the secure virtual private domain to one or more network carriers, a settlement server for processing usage data upon completion of a network connection, and a secure domain name server for storing records associated with the one or more devices in the secure virtual private domain.

In accordance with some embodiments, a method of providing opportunistic internet connections is provided. The method comprises: automatically determining a tariff in order to access a network of a network provider so as to allow a communication device not having a network account with the network provider to connect to the network through a second communication device having a different network account.

### BRIEF DESCRIPTION OF THE DRAWINGS

FIG. 1 depicts a high-level secure virtual private domain configuration, in accordance with some embodiments of possible devices that can be a part of the configuration.

FIG. 2 depicts a high-level block diagram of a system implementing various embodiments of a secure virtual private domain.

FIG. 3 depicts a time line or sequence steps of an example of a process of setting up a financial services account.

FIG. 4 depicts a time line or sequence steps of an example of a process of configuring an account negotiation server.

FIG. 5 depicts a time line or sequence steps of an example of a process of configuring a settlement server.

FIG. 6 depicts a time line or sequence steps of an example of a process of authorizing negotiation of sub-domain devices.

FIG. 7 depicts a time line or sequence steps of an example of a process of automatically negotiating a connection.

FIG. 8 depicts a time line or sequence steps of an example of a process of settlement and funds transfer.

FIG. 9 depicts a time line or sequence steps of an example of a process of negotiating on behalf of another SVPD device.

### DETAILED DESCRIPTION

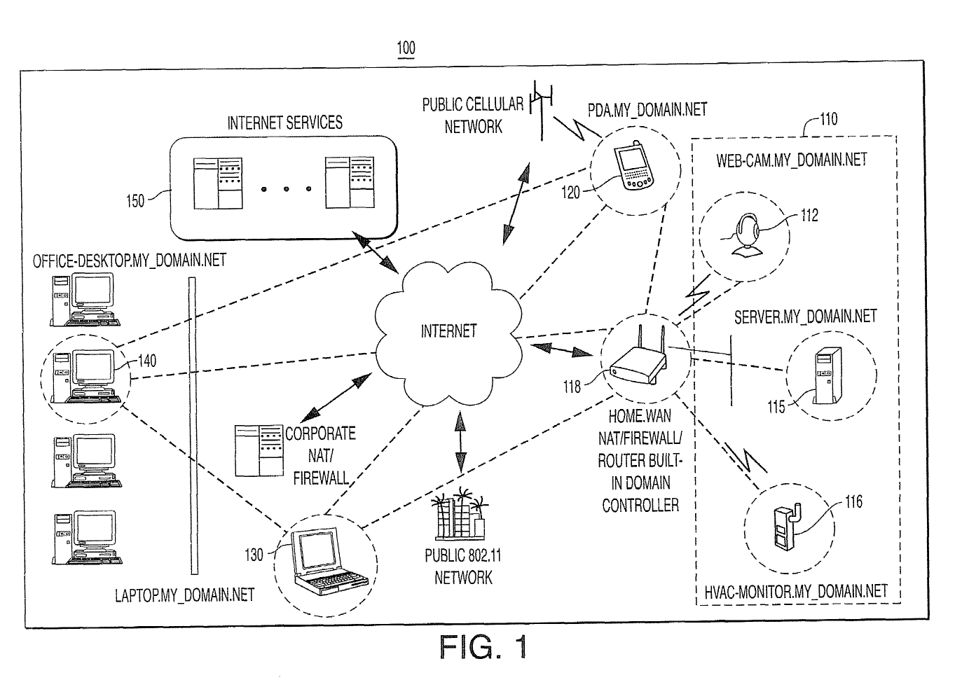

FIG. 1 is a high-level overview depicting the concept of a secure virtual private domain (SVPD), in accordance with various disclosed embodiments. As depicted in FIG. 1, a plurality of geographically dispersed devices may be connected to form an SVPD 100 having a unique domain name, e.g., “my_domain.net,” associated therewith. SVPD 100 may include, for example, a plurality of home devices 110, a portable handheld electronic device 120, a laptop computer 130, and an office desktop computer 140. Home devices 110 may include, for example, a web camera 112, a server 115, a home status device 116, and/or other home devices. It is noted that the devices depicted in FIG. 1 are merely exemplary; since any combination of devices may be present including other devices capable of some type of electronic communication. As depicted, the home devices 110 may form a home network and may be located behind a network firewall. Router 118 may be configured for connecting home devices 110 to the Internet.

Portable handheld electronic device 120 may include, for example, a Blackberry, PDA, web-enabled mobile phone, and/or any other network enabled mobile communication device. Device 120 may be connected to the network via a public cellular network, while laptop computer 130 may be connected via a public wireless access point. Office desktop computer 140 may be located behind a corporate firewall.

The devices depicted in FIG. 1, while geographically dispersed, form part of a single SVPD. Cryptographically secure tunneling provides private connections across the virtual network. Each device is a sub-domain device of the virtual domain and has a specific and unique sub-domain name associated therewith.

According to some embodiments, modes of operation vary depending on the device type. For example, downloadable software development kits and device drivers may be deployed for programmable computing devices such as desktop computers, laptops, smart phones, etc. Software modules may be included which intercept network packets entering and leaving the device, and may process these packets to provide various SVPD services.

For example, the software modules may enable device domain name registration and certificate negotiation, network connection discovery, dynamic presence registration, domain peer lookup, firewall traversal, automatic VPN protocol negotiation, and/or other SVPD services. For low-end devices such as home monitoring equipment, appliances, etc., a single semiconductor chip or chip set may be embedded into the device, the chip or chip set enabling the SVPD functionality.

In accordance with exemplary embodiments, one or more of the devices depicted in FIG. 1 may be configured as a domain controller. As domain controller, the designated device may be configured to register the other devices as part of the SVPD, and to assign sub-domain names. A device may become a domain controller by registering with SVPD management servers 150. SVPD management servers 150 may be configured to provide secure domain name registration, domain certificate issuance and revocation, authenticated dynamic DNS, relay services for network address traversal (NAT), and/or other provisioning services. SVPD servers 150 may be hosted at a secure data source, and may be configured to incorporate dynamic backup and roll-over functions.

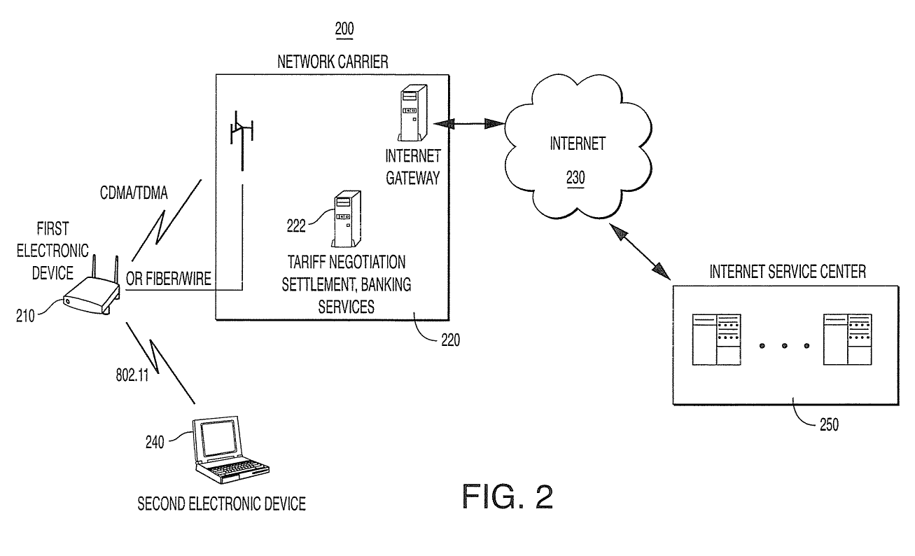

FIG. 2 is a high-level system configuration 200 implementing various disclosed embodiments for facilitating automatic tariff negotiation. A first device 210 may be communicatively connected to a network carrier 220, which enables first device 210 to reach the Internet 230. First device 210 may be any electronic device configured to receive opportunistic connections. As used herein, opportunistic connections refers to the ability to serve as a gateway for connecting other devices to the Internet. First device 210 may be, for example, a router, server, laptop, desktop, or other network device. In some embodiments, first device 210 may be configured with SVPD functionality, as described above in reference to claim 1, enabling the device to establish secure virtual private domains with other geographically dispersed devices.

Network carrier 220 may be any communication network such as, for example, Verizon, Sprint, T-Mobile, and/or other network carriers. Network carrier 220 may be registered to provide SVPD services, and may have associated therewith a plurality of negotiation services. In some embodiments, a single physical server 222 may provide the plurality of negotiation service functions, while in other embodiments, multiple servers providing such functions may be present.

The plurality of servers or server functions may include, for example, a financial services server function, a negotiation server function, a settlement server function, and a secure domain name services server function. Other servers may also be provided.

Financial services server or server function may be achieved by a configuration designed configured to create financial accounts with one or more SVPDs. For example, a domain controller device may create a financial account enabling the automatic payment of tariffs associated with network communication for itself and other members of its domain. Financial services server may communicate with a payment service (not shown) associated with an SVPD in order to process financial data. Payment services may include, for example, a bank, credit card company, or other financial institution for which the SVPD has one or more accounts.

A negotiation server or server function may be achieved by a configuration designed configured to automatically negotiate tariffs for connecting devices to a communications network carrier. In some embodiments, the communications network carrier may be a carrier for which the device desiring to connect does not have an account. It other embodiments, the device may have an account with the communications network carrier, but may reach it remotely (i.e., roaming). The negotiation server may be configured to develop a plurality of rules which are acceptable to a particular device and/or domain for negotiating with a network carrier on its behalf. A settlement server or server function may be configured to settle the financial accounts when a communication session is completed. This may include, for example, finalizing the payment of any tariffs which are due. A SDNS server or server function may be configured to store and update DNS records associated with a device and/or domain.

A second device 240 may discover first device 210 and initiate a connection. Similar to first device 210, second device 240 may include SVPD functionality in accordance with some embodiments. As depicted in FIG. 2, second device 240 may wish to connect to the Internet 230, but does not have a connection to network carrier 220. However, in accordance with exemplary embodiments, second device 240 does have a network account with internet service center 250, which is configured to automatically negotiate on behalf of second device 240. Internet service center 250 may be a network service provider or may be a dedicated SVPD service provider. Thus, network carrier 220 and internet service center 250 may negotiate a tariff and enable second device 240 to connect to the Internet.

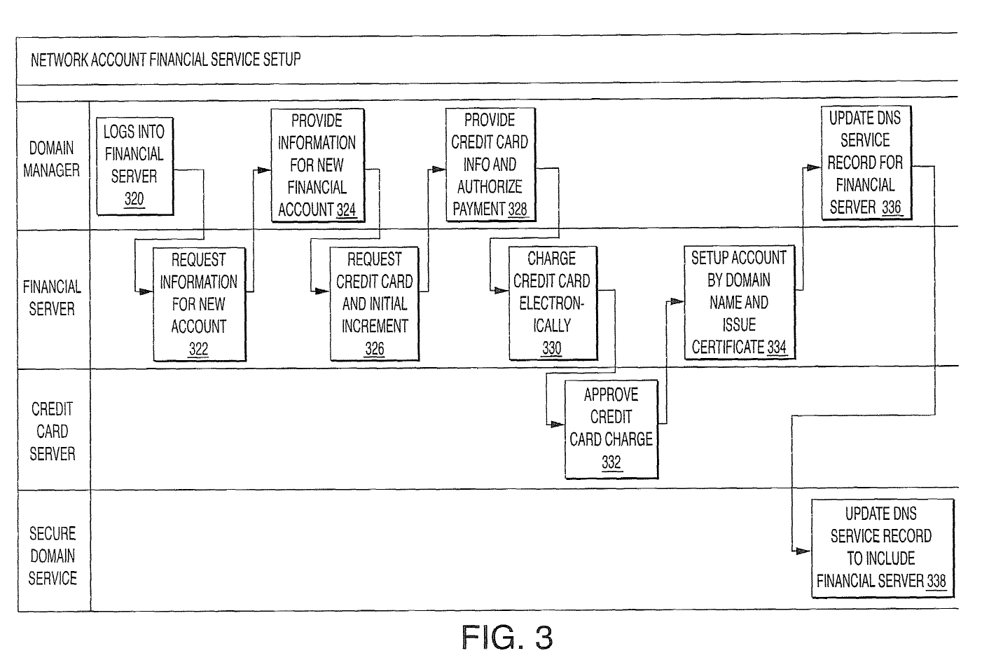

FIG. 3 is a functional diagram illustrating an exemplary sequence of steps of a method 300 wherein the owner of a domain controller may configure a financial services account. While the example depicted in FIG. 3 refers to a domain controller configuring a financial service account, any device, whether or not it belongs to an SVPD, may create a financial services account to facilitate automatic tariff negotiation. The financial services account facilitates automatic negotiation and settlement of network tariffs. As depicted at 320, the process may begin when a domain controller logs into a financial server associated with its network services account. For example, the financial server may be located at the network carrier location where the domain controller has an account, or may be provided at an SVPD service provider. Logging in may include, for example, exchanging a login ID and security credentials such as a public key and/or signed certificate.

After logging in, the domain controller may issue a request for a new financial services account, and the request may be received by the financial server, as depicted at 322. The domain controller may then provide information for establishing a financial services account, as depicted at 324. This information may include, for example, a name associated with the account to be established, address, telephone number, email address, and/or other information.

Upon receipt of the initial information for establishing an account, the financial server may request payment information, as depicted at 326. Payment information may include, for example, a payment account number, and an initial payment amount to be charged. Payment accounts may include, for example, a checking account number, a savings account number, a credit card number, and/or any other payment accounts. As depicted at 328, the domain manager provides the requested information and authorizes payment.

As depicted at 330, the financial server electronically charges the designated payment account for the initial increment. Upon receipt of the electronic payment information, the payment account service may approve the charge, as depicted at 332. If, however, the charge is not approved, the financial server may contact the domain controller to request an alternate payment account or verification of the account information provided.

Once a valid payment has been approved, the financial server may set up the financial service account for the domain controller and issue a certificate, as depicted at 334. As depicted at 336 and 338, the domain controller and the SDNS may update the DNS records to include the financial server.

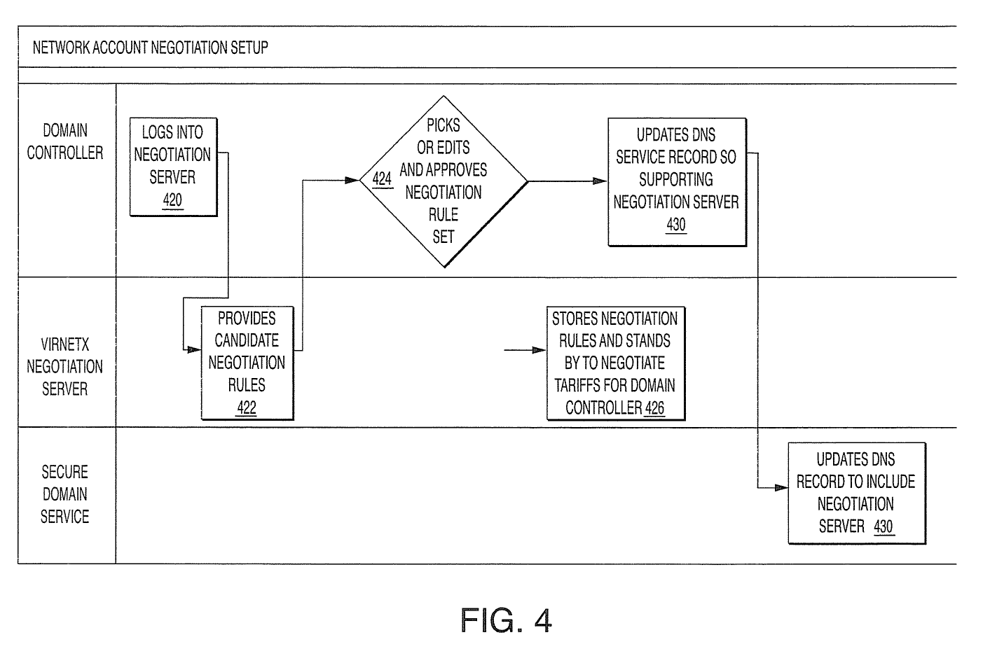

A domain controller having a valid financial services account may establish rules for automatically accepting tariffs for connections for itself and other devices within its domain. FIG. 4 depicts a diagram illustrating an example of sequence of steps of a process 400 for establishing tariff negotiation rules.

As depicted at 420, a domain controller may log into a negotiation server. Again, while a domain controller is depicted in FIG. 4, the method may be performed by any network device, whether or not it belongs to an SVPD. According to some embodiments, the negotiation server may provide the domain controller with a list of candidate negotiation rules, as depicted at 422. This enables the domain controller to select those rules deemed appropriate. As depicted at 424, the domain controller may decide whether to accept, decline, or edit one or more candidate rules. In considering whether to accept rules, the domain controller may consider factors such as cost and quality of service.

Once the rules have been selected by the domain controller, the negotiation server may store the agreed upon rules, as depicted at 426. Using the rules, the negotiation server is now configured to negotiate with other network carriers or services on behalf of the domain controller. As depicted at 428 and 430, the domain controller and SDNS server may update DNS records to include the negotiation server.

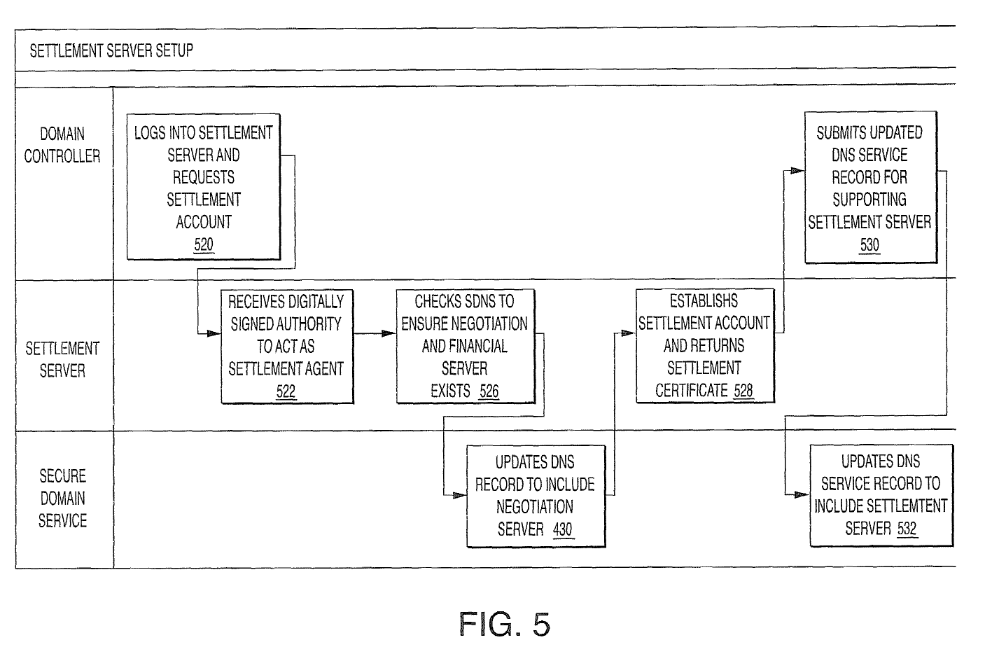

A domain controller or other network device, whether or not it belongs to an SVPD, may also be configured to authorize a settlement server to settle its network tariff payments. FIG. 5 depicts a diagram of an example of sequence of steps of a process 500 for configuring a settlement server.

As depicted at 520, the domain controller may log into the settlement server and request a settlement account. The request may include, for example, a digitally signed authority to act as a settlement agent. Once the settlement server receives the digitally signed request, as depicted at 522, the settlement server may ensure that the negotiation and financial services exist by performing a lookup to the SDNS, as depicted at 524.

As depicted at 526, the SDNS responds to the lookup by providing the settlement server with the negotiation and financial server certificates. A settlement account may then be established as depicted at 528, and a settlement certificate may be provided to the domain controller. The domain manager and SDNS may then update the SDNS records as depicted at 530 and 532, respectively.

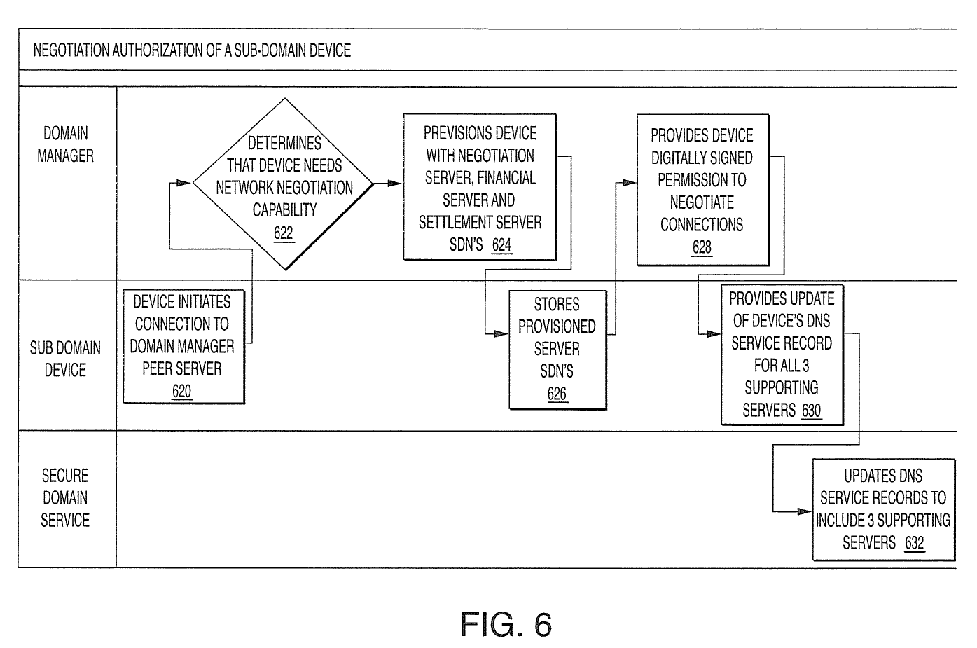

According to some embodiments, a sub-domain device may be provisioned to allow automatic negotiation on its behalf. FIG. 6 depicts an example of a sequence of steps of a process 600 for authorizing the tariff negotiation for a sub-domain device.

As depicted at 620, a sub-domain device may initiate a connection to its domain controller. The domain controller may then determine whether the sub-domain device needs tariff negotiation capability, as depicted at 622. If the sub-domain device needs provisioning, the domain controller provides the necessary information to the sub-domain device.

As depicted at 624, the domain controller provides to the sub-domain device the DNS records associated with the servers which have been configured to negotiate on behalf of the domain. These servers may include, for example, the financial server, the negotiation server, and the settlement server described above. The sub-domain device stores the DNS information, as depicted at 626.

As depicted at 628, the domain controller may provide to the sub-domain device digitally signed permission to negotiate connections. The sub-domain device then updates its DNS service records for the supporting servers, as depicted at 630, ad the updates are recorded at the SDNS, as depicted at 632.

Once a sub-domain device has been provisioned with SVPD negotiation capability, it may initiate a connection from any location where it can reach a SVPD-enabled network carrier. For example, a sub-domain device, such as a laptop computer having a network account with a particular network carrier, may connect to the Internet via another SVPD-enabled network carrier configured for automatic negotiation.

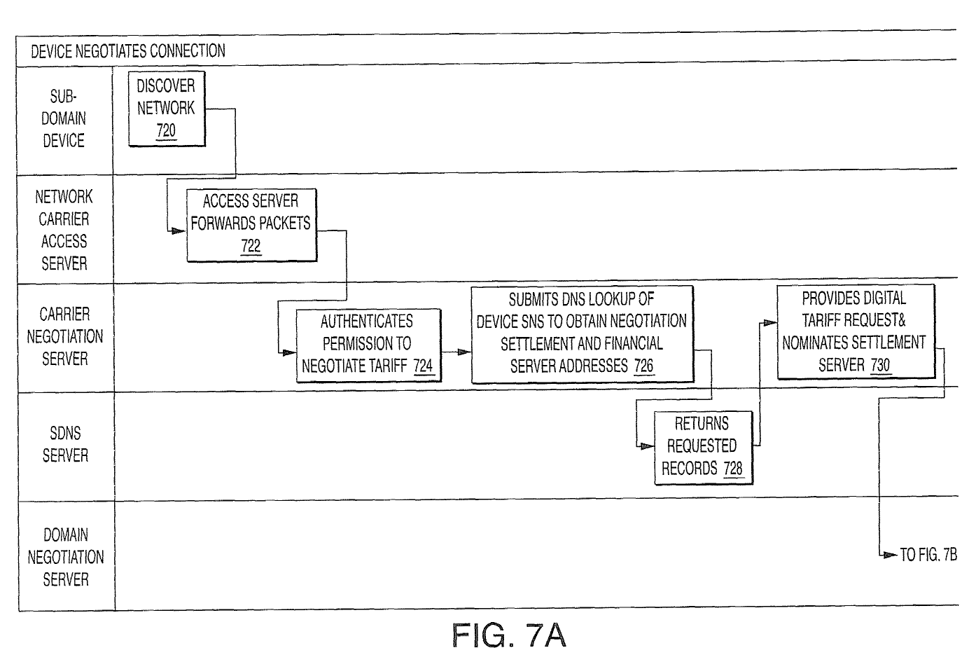

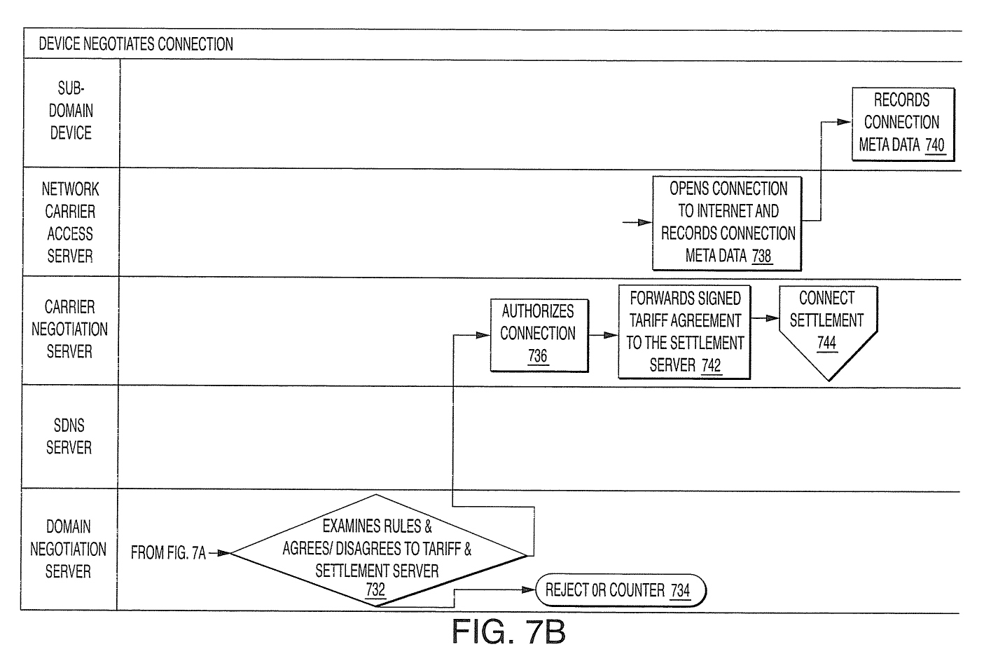

FIG. 7 illustrates an example of a sequence of steps for a process in which a sub-domain device negotiates a connection. As depicted at 720, a sub-domain device may discover its network. When the device discovers a network, the SVPD modules associated with the device initiates a connection. When an access server associated with the desired network receives communication from the sub-domain device, the packets are forwarded to the network carrier negotiation server, as depicted at 722. As described above, the carrier negotiation server may be located at the SVPD service center or at a location associated with the carrier network.

Upon receipt of the communication packets, the carrier negotiation server authenticates permission to negotiate the tariff, as depicted at 724. The carrier may then determine the addresses associated with the device's financial, negotiation, and settlement servers by performing a DNS lookup to the device's SDNS, as depicted at 726. The SDNS returns the requested data, as depicted at 728.

As depicted at 730, the communication network carrier's negotiation server provides a digital request for a tariff and nominates its settlement server. In response to the tariff request and settlement server nomination, the SVPD domain negotiation server examines the rules in place for the SVPD, and determines whether to agree to the tariff and settlement server, as depicted at 732. The SVPD domain negotiation server may reject or counter the tariff and settlement server, as depicted at 734, or may accept and authorize the connection, as depicted at 736.

Once the connection has been authorized, the network carrier access server may open a connection to the Internet and record connection meta data, as depicted 738. The connection meta data may also be recorded by the sub-domain device, as depicted at 740. Additionally, the communication network's negotiation server may forward the singed tariff agreement to the settlement server, as depicted at 742, and connect to the settlement server, as depicted at 744.

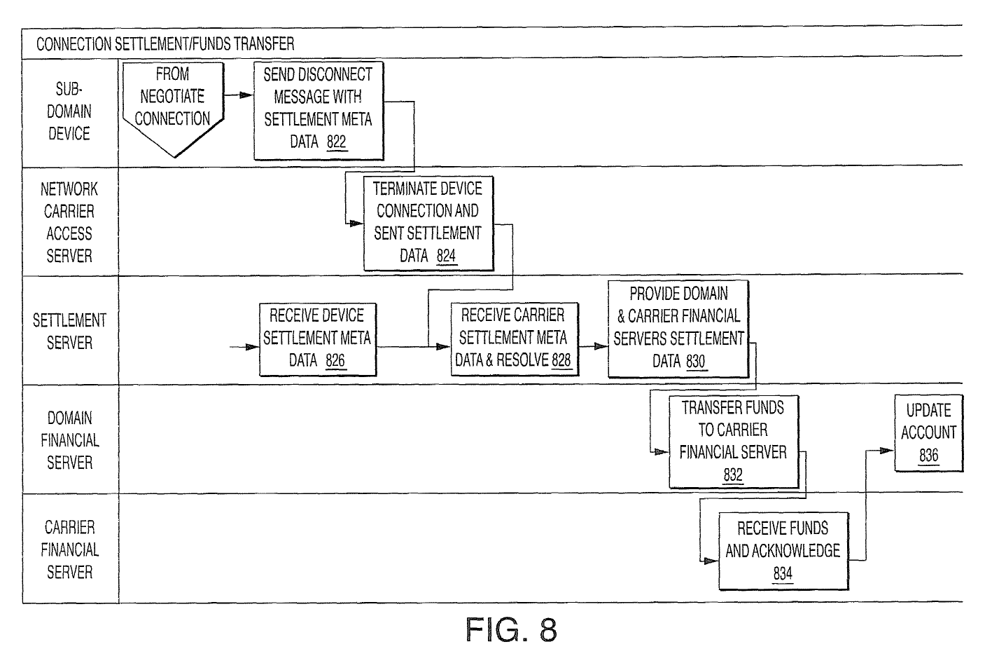

The bookkeeping and settlement may be accomplished, for example, using the Open Settlement Protocol (OSP). OSP is a protocol that enables the exchange of inter-domain pricing, authorization, and settlement information between internet telephony operators. Other methods of settlement may be used. FIG. 8 depicts an example of a sequence of steps of a settlement process 800. At least one settlement server may be associated with each SVPD device. Thus, in the example depicted in FIG. 8, both the sub-domain device and the network carrier may have at least one settlement server associated therewith. According to some embodiments, more than one settlement server may be provided for backup. The settlement servers are listed in the DNS records for the SVPD device.

While connected to a network, a device may periodically provide notification to the settlement server indicating that the device is still connected. For example, heartbeat messages may be provided at predetermined time intervals to the settlement server. As depicted at 822, when a communication session is complete, the sub-domain device may send a disconnect message. The disconnect message may include metadata characterizing the communication session. Metadata may include, for example, the communication start time, end time, amount of data exchanges, services used, and/or other metadata.

As depicted at 824, when the network carrier access server receives the disconnect message, it terminates the connection and sends settlement metadata to its settlement server, which was elected during the connection process. The settlement server receives settlement metadata from the sub-domain device, as depicted at 826, as well as from the network carrier access server, as depicted at 828. The settlement server reviews and reconciles the settlement data, and provides the data to the sub-domain device's financial server, as depicted at 830. Upon receipt of the data, the sub-domain device's financial server transfers funds to the carrier's financial server, as depicted at 832. Upon receipt and acknowledgement of the funds by the carrier's financial server, as depicted at 834, the sub-domain device's financial server updates the account.

According to some exemplary embodiments, a device which has been configured for automatic tariff negotiation may allow connections from other devices belonging to other domains. That is, when a device initiates a connection to a local subnet, a device from another domain or associated with another network carrier can offer Internet gateway or relay services to an Internet gateway. If the available gateway has a negotiated tariff, a tariff for the attaching device can be negotiated automatically. The negotiated tariff may be shared between the owner of the supporting domain controller and the network service provider.

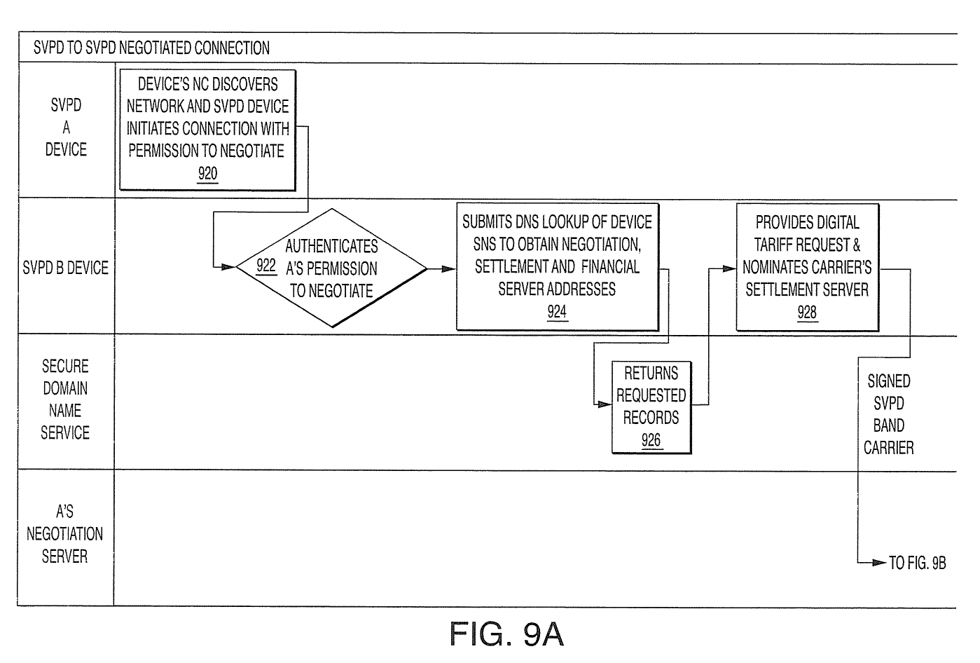

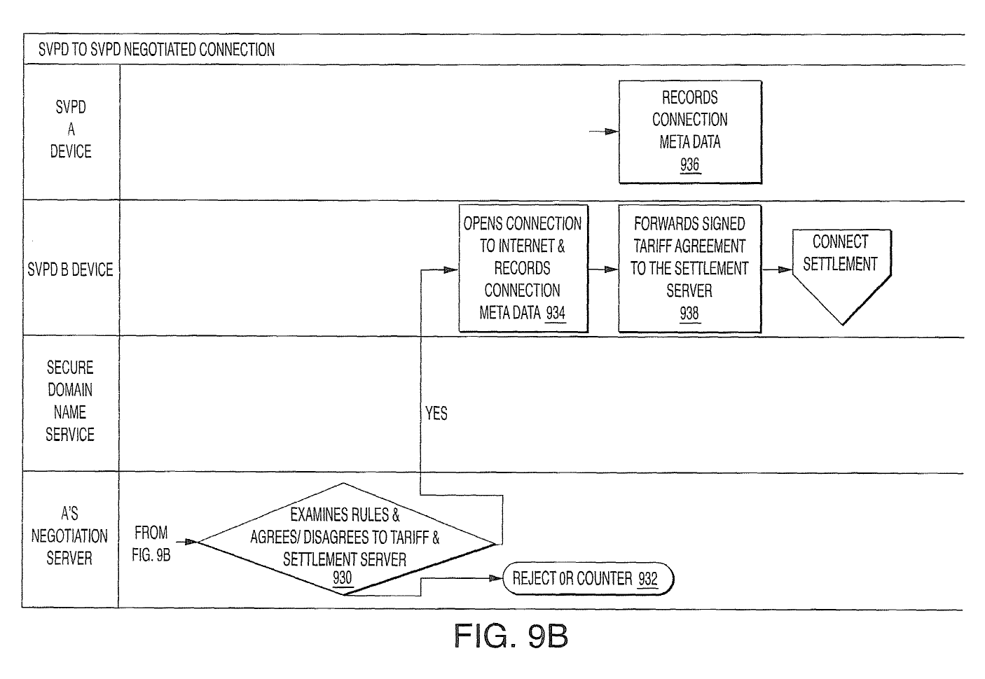

FIG. 9 depicts an example of a sequence of steps of a method 900 for providing SVPD to SVPD negotiated connections. However, the method illustrated in FIG. 9 also applies to non-SVPD devices.

As depicted at 920, SVPD_A device may discover the SVPD_B device and initiate a connection. As depicted at 922, SVPD_B authenticates the permission to negotiation, and submits a DNS lookup to its SDNS to obtain the addresses of its financial, negotiation, and settlement servers, as depicted at 924. The SDNS returns the requested address information, as depicted ate 926.

As depicted at 928, once SVPD_B has received the necessary DNS information regarding SVPD_A's servers, SVPD_B provides a signed digital tariff request and nominates its settlement server to settle the account. This information is provided to SVPD_A's negotiation server, which was discovered via DNS lookup. The tariff request may include the rules required by SVPD_B for enabling connections.

SVPD_A's negotiation server may examine the tariff request and decide whether it agrees with the rules and settlement server provided, as depicted at 930. If the negotiation server does not agree, it may reject or counter, the offer, as depicted at 932. Factors in determining whether to accept the rules may include cost, connection speed, quality of service, and/or other factors.

If SVPD_A's negotiation server accepts the rules and settlement server, SVPD_B opens a connection to the Internet and records connection metadata, as depicted at 934. The metadata may also be recorded by SVPD_A, as depicted at 936. Upon completion of the communication session, SVPD_B forwards the signed tariff agreement to its settlement server, as depicted at 938.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims.

What is claimed is:

1. A method of providing opportunistic internet connections, comprising:
receiving a request from a first electronic device having network account with a first entity to negotiate a connection for a second electronic device;
determining a network account associated with the second electronic device; and
automatically connecting the second electronic device in accordance with one or more rules including determination of a tariff for making the connection.

2. The method of claim 1, wherein the network account associated with the second electronic device is with a second entity, and wherein automatically connecting the second device includes negotiating the tariff for making the connection.

3. The method of claim 2, wherein negotiating a tariff comprises:
receiving one or more negotiation rules from a negotiation server associated with the second electronic device;
comparing the one or more negotiation rules from the negotiation server associated with the second electronic device with one or more pre-authorized rules associated with the first electronic device; and
accepting the tariff if the rules from the negotiation server associated with the second electronic device do not conflict with the one or more pre-authorized rules associated with the first electronic device.

4. The method of claim 3, wherein the one or more negotiation rules from the negotiation server associated with the second electronic device includes rules indicating one or more of the minimum connection speed required and a minimum acceptable quality factor.

5. The method of claim 1, wherein network account associated with the second electronic device is with the first entity, and the first electronic device connects to the second electronic device remotely by roaming through a network associated with the second entity.

6. The method of claim 1, wherein determining a network account associated with the second electronic device comprises performing a DNS lookup of the second electronic device to find a negotiation server associated with the second electronic device.

7. The method of claim 6, wherein the network account associated with the second electronic device is with a second entity, and wherein the second entity is a second internet service provider different from the first internet service provider.

8. The method of claim 1, wherein the second electronic device connects to the network via the first entity after the tariff has been determined.

9. The method of claim 1, wherein the first entity is a first internet service provider.

10. The method of claim 1, wherein the first entity is a dedicated secure virtual private domain (SVPD) service provider.

11. The method of claim 1, wherein upon completion of the connection, the tariff is calculated based on metadata associated with the connection.

12. The method of claim 11, wherein the metadata includes one or more of the duration of the connection, the amount of data exchanged, and the protocols used.

13. A system for automatically negotiating network connections comprising:
a financial server configured to create a financial account associated with a secure virtual private domain;
a negotiation server configured to automatically negotiate tariffs for connecting one or more devices in the secure virtual private domain to one or more network carriers;
a settlement server for processing usage data upon completion of a network connection; and
a secure domain name server for storing records associated with the one or more devices in the secure virtual private domain.

14. The system of claim 13, wherein the financial server is configured to process tariff payments from one or more of a checking account, savings account, or credit card.

15. The system of claim 13 wherein the negotiation server is configured to automatically negotiate tariffs based on one or more rules selected by a domain controller associated with the secure virtual private domain.

16. The system of claim 13, wherein the one or more rules includes a rule specifying a connection fee schedule.

17. The system of claim 13, wherein the one or more rules includes a rule specifying a quality of service metric.

18. A method of providing opportunistic internet connections, comprising:
automatically determining a tariff in order to access a network of a network provider so as to allow a communication device not having a network account with the network provider to connect to the network through a second communication device having a different network account.

19. A method of claim 18, wherein automatically determining a tariff includes automatically negotiating the tariff when the different network account is with a different network provider.

20. A method of claim 18, wherein automatically determining a tariff includes a predetermined tariff when the different network account is with the same network provider.
